(19) United States
(12) Patent Application Publication
(10) Pub. No.: US 2002/0116374 A1
(43) Pub. Date: Aug. 22, 2002

(54) Web-centric design and engineering technologies, integration methods and optimization of engineering-to-procurement business process supply chain

(76) Inventors: Srinivas Bette, Plano, TX (US); Prabodh Pathak, Plano, TX (US)

Correspondence Address: Srinivas Bette, 5856 Bridle Bend Ct., Plano, TX, 75093, US

(21) Appl. No.: 10/074,427

(22) Filed: Feb. 11, 2002

Related U.S. Application Data
(60) Provisional application No. 60/270,318, filed on Feb. 20, 2001.

(51) Int. Cl. G06F 7/00

(52) U.S. Cl. 707/3

(57) ABSTRACT

A system and a method for integrating design/engineering-to-procurement business process supply chain are provided. A buyer/user can access the technologies to perform design calculations using dynamic, real-time market data, and proceed to procure the selected equipment. A seller/user can list equipment and services on the system, and provide necessary data for design and engineering and transactions. A seller can also access and use technologies. A database consisting of technical and financial data specific to this fully integrated system is provided. The system is web-centric and can be accessed via the Internet or on local intranets. The system provides links to back offices systems, external catalogs, external marketplaces, and other services such as financial and fulfillment. A design methodology that integrates the engineering calculations with optimization of equipment selection based on dynamic market data is presented using a gas pipeline example. A new reliability based method for equipment design, which uses specific probabilistic material data from the marketplace is provided. This method also provides optimization methodology, which combine technical and financial data to obtain risk weighted optimal results.

This application is based on the provisional patent application ser. No. 60/270,318 filed Feb. 20, 2001. Pursuant to U.S.C. 119(e)(i) applicants claim priority of provisional patent application.

### BACKGROUND

1. Field of Invention

This invention generally relates to the field of computer-implemented design, optimization and business processes; more particularly, the invention relates to a method and apparatus to facilitate the use of novel techniques for optimizing design, engineering and decision-making by integrating internal business processes with business-to-business procurement marketplaces, and hosting these systems for access over the Internet and the Intranet.

2. Description of Prior Art

Every year over 100 billion dollars are invested in the Upstream (Exploration-to-Production of Oil & Gas) Petroleum industry. The current processes and methodologies for organizing and coordinating these investments (capital spending) are inefficient and inadequate because of the following problems faced by the companies in the industry:

Tendency to over-engineer and design in an attempt to be risk averse, thereby increasing the cost of the investment:

At present the entire investment process is inefficient because, for one, the design techniques are conservative (risk averse) and old and second, the engineering (technology) to procurement processes are disjointed. Traditional and standard design and engineering techniques are discrete in formulation. They use extreme values to determine load and strength. Further, to address safety and to lower risk, they employ safety factors to separate the extreme values. These methods do not have the ability to assess and quantify risk. For example, see Petroleum Well Construction: Economides, et. al. John Wiley & Sons, 1998.

Limited use of computer implemented and mathematical techniques like probabilistic design and optimization technology in the design process. Limited or no integration of engineering consideration with economic outcomes/costs:

In general, the petroleum industry does not employ probabilistic methods. Moreover, none use an integrated engineering approach to optimize the outcome, Optimization of capital investments has two components: one, optimal engineering, and second, optimal economic outcome. Independently optimizing these components do not necessarily produce optimal overall results. The integrated approach of engineering and economics is not in general applied in the industry.

Existence of complex, interrelated processes that are managed separately and not as parts of one continuous integrated process:

The Upstream Petroleum industry consists of complex interrelated processes. Due to the breadth of disciplines involved, and the complexity of each activity, these processes have remained in silos. For example, as shown in FIG. 1., geoscience analysis to delineate the underground resources is done independent of most engineering considerations. Subsurface engineering such as drilling, completions and reservoir analysis are also, in most instances, done independently. After these analyses are done, surface engineering is taken up. Procurement for each of these activities is also done independently. All of these happen in a sequential fashion with little or no feedback for improving design or efficiency.

Disconnection between the design process and procurement adding a layer of inefficiency and additional costs:

In an oil and gas company, today design and engineering and market dynamics of capital goods are tied together. Consider for example the well design and procurement of equipment such as casing, tubing, etc. The drilling engineer performs a casing or tubing design based on extreme values on load, strength of materials and operational conditions. These produce a set of specifications for materials, which are then sent to the procurement department. The engineer is generally not involved in the procurement process. The procurement department secures the best deal based on the specifications, timing etc. Often the lead-time for these materials can be long. To over come this long lead-time, large to medium-sized companies keep some material in inventory in warehouses. If the available material meets the specifications the issue is addressed. If not, the tendency is to use material, which exceeds the specifications so that safety is not compromised. This leads to over design. In cases when there is no inventory or a warehouse, an approximate, and safe design is produced and sent for procurement. Later a detailed design is done to ensure operational integrity and safety. Again to overcome cycle time inefficiencies designs tend to be overly conservative. Furthermore, market dynamics are never tightly integrated to the design process to optimize the economic outcome. This is generally true for the engineering components of the upstream industry.

Efforts to optimize sub-processes without optimizing the overall process:

Today, various business components and processes in an oil and gas company are looked at individually and optimized for specific metrics. The sum of individually optimized components rarely produces a globally optimized solution for the whole project. The techniques to integrate the business process and solve the entire problem are not available.

The upstream industry is a complex, inter-related natural resource industry and conventional discrete and process models do not work. The prior art (For example, U.S. Pat. Nos. 5,890,133; 5,953,707; 5,974,395; 6,119,149; 6,151,582; 6,332,155; 6,343,275) comprises largely of efforts by traditional Enterprise Resource Planning (ERP) and supply chain management (SCM) software which have addressed some of the generic business processes such as accounting and procurement, but have not been able to fully address the upstream petroleum industry problems because of lack of domain knowledge and, in any case, address none of the design and engineering challenges that currently exist. Most of the new e-commerce ventures have focused only on procurement of goods on a B2B hub. These approaches address part of the overall problem but do little to improve business processes or provide a tight supply chain. Thus, at present, significant problems and inefficiencies exist in the design, engineering, decision-making and procurement processes associated with large capital spending projects and there remains a significant need for improved methods and apparatus to facilitate the optimization of these processes.

### SUMMARY

In accordance with the present invention, a computer-related method and apparatus for integrating design and engineering technologies with the procurement marketplaces is provided that will significantly eliminate the disadvantages of the prior systems, improve efficiency, and produce optimal designs for technical and economic decisions. While the process, systems and methods are described using the upstream oil industry examples, the methods are applicable to a broad range of industries as will be readily apparent to those skilled in the art.

### OBJECTS AND ADVANTAGES Accordingly several objects and advantages of the invention are:

1. to provide systems and methods for Integrating of engineering to procurement business process supply chain.

2. to provide a novel probabilistic design methodology that Integrates market technical/financial data for optimal design.

3. to provide capability for simultaneous optimization of engineering and commercial variables for risk weighted optimal economic decisions

4. to provide a hub over the Internet for dynamic integrated collaborative engineering and procurement.

5. to host the technologies and the marketplace hub at a central location, which provides access to broad class of customers at low costs.

6. to provide systems and methods for cycle time reduction and increase in productivity.

7. A to provide an Internet platform that seamlessly connects buyers and sellers, and that Integrates with individual back office systems.

8. to develop and make available to users a database of information that allows for the appropriate evaluation of probabilities of relevant events/occurrences and the quantification of various categories of risk to make risk weighted decisions.

### BRIEF DESCRIPTION OF THE DRAWINGS

A more complete understanding of the present invention and the advantages thereof may be obtained by referring to the following description of the drawings, in which the like reference numbers indicate the like features.

FIG. 1: Diagram of the existing sequential and disjointed engineering and procurement supply chain.

FIG. 2: Block diagram of the integrated technology/marketplace hub showing the interactions between various entities.

FIG. 3: Details of the integrated technology/marketplace hub showing the communication paths.

FIG. 4A; Is an example of integrated design & procurement of pipelines.

FIG. 4B: Flow chart of the system, method and process of the integrated design, selection & procurement of pipelines.

FIG. 5A: Is an example of Optimized Reliability Based Design (ORBD™) of subsurface equipment closely integrated with Marketplace for dynamic optimized design and procurement. FIG. 5B: Flow chart of the system, method and process of the example shown in FIG. 5A.

### DETAILED DESCRIPTION OF INVENTION

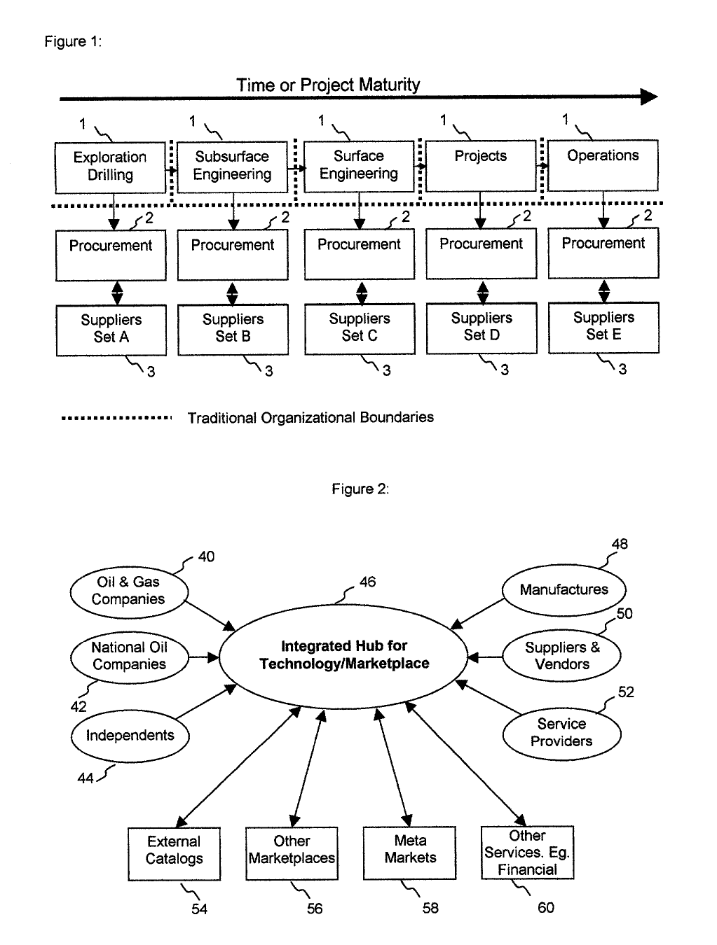

FIG. 1 is a block diagram of the existing sequential and disjointed engineering to procurement business process supply chain. Typically during the life cycle of an Upstream Petroleum industry oil and gas field project activities progress from Exploration 10 to Subsurface engineering 12 to Surface engineering 14 to Capital Projects 16 to Operations 18 before the field is abandoned. Each one of these activities is separated by an organizational boundary. Although there is interaction between these departments, they are not integrated. The work done in each unit is well defined and there is a specific hand off from one to the other. During each phase there is specific activity that needs procurement of capital goods, which are required for field activity. For example, Exploration 10 drilling will need the design and purchase of drilling equipment and services. This is in general interfaced through the drilling department, which in turn interfaces with the procurement function. Subsurface engineering 12 will for example take on appraisal and development drilling. Surface engineering 14, for example, will handle the engineering surface facilities, pipelines, platforms, etc. Then the capital projects 16 take on the role of managing the Design, Engineering, Procurement and Construction (EPC) phase of the project, until it is handed over to Operations 18. The procurement department 20-28 is in general a separate organization from the rest of the line functions. At each stage of the project they interface with the various units. Here again the process is sequential not integrated. The procurement department 20-28 in turn interacts and interfaces with the suppliers 30-38. The set of suppliers at each stage could be different. The organizational units, their interfaces and level of integration vary depending on the size of the company. However, in all cases there is little or no integration of engineering with procurement and market data.

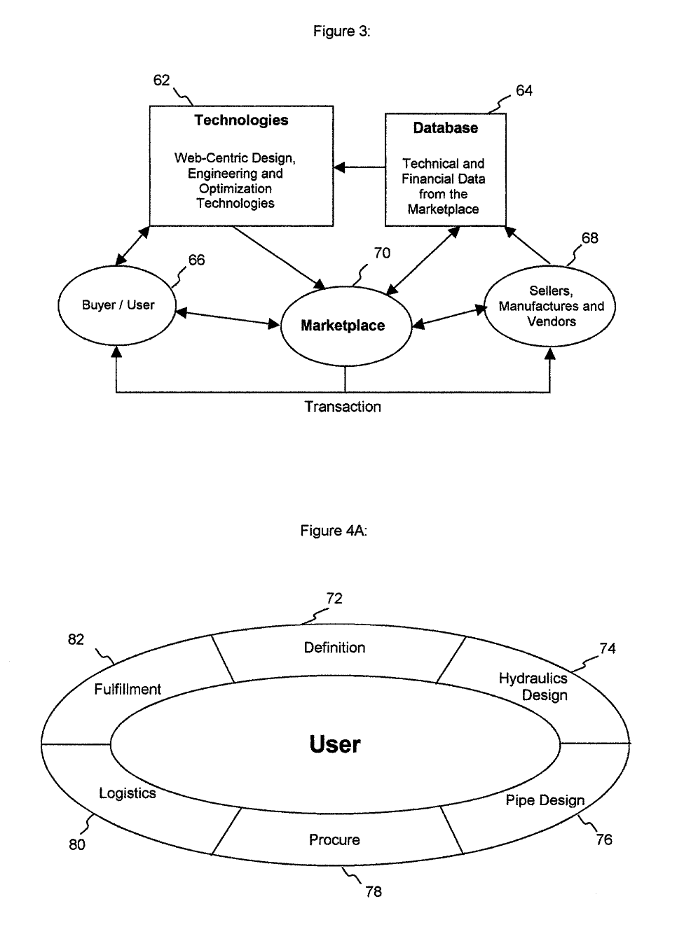

FIG. 2 is block diagram of an integrated technology/marketplace hub showing the interactions between various entities. An integrated Hub 46 consists of a platform that will encompass both technology and commercial functions. This Hub 46 is hosted on a server for access over the Internet or Intranet. Oil & gas companies 40, National oil companies 42 (Companies in foreign countries where the government has a controlling stake) and Independent oil companies 44 access the hub 46 to use technologies and dynamically interact and procure on the marketplace. Manufacturers 48, suppliers & vendors 50 and service providers 52 either list their products on the marketplace or provide access to their catalogs. Sellers 48, 50 & 52 also have the advantage of accessing technologies such as product configurator or an optimization tool to enhance their internal supply chain and margins. Hub 46 is a full function marketplace with capabilities to perform transactions including request for quotes/proposals (RFQ/RFP), auctions, reverse auctions and purchase orders (PO). Hub 46 also provides interfaces with back office systems of both buyers and sellers. Hub 46 has an interface that connects to external product catalogs 54, other marketplaces 56, Meta markets 58 and other services 60 such as financial, fulfillment and logistics.

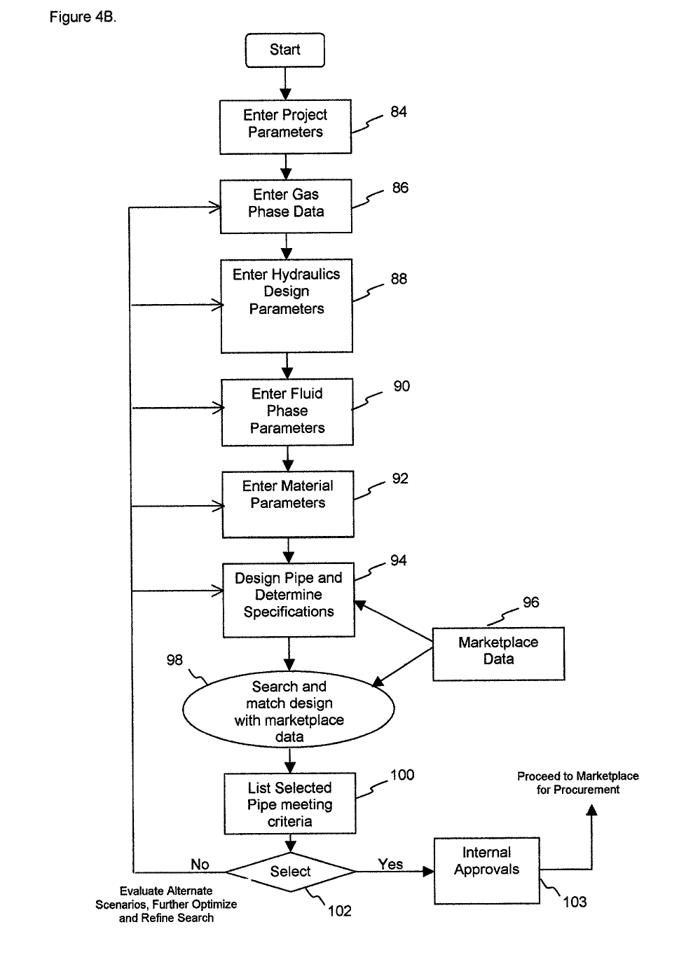

FIG. 3 is a detail of the integrated technology/marketplace hub 46 showing the communication paths. A buyer/User 66 accesses technologies 62 to perform design, engineering and optimization calculations. Technologies 62 interface with a database 64 containing technical and financial data from the marketplace. Database 64 contains specific data necessary to perform the design, engineering and optimization calculations. A unique data format is also used. Sellers 68 populate and update the database on a regular periodic basis. Embodiments 62 & 64 are integrally connected to a marketplace 70, in which the outcome of 62 and data from 64 are used in the procurement transaction. Marketplace 70 allows for buyer 66 and seller 68 to connect and execute a transaction. Marketplace 70 could also include or connect to other marketplaces 56, external catalogs 54 Meta markets 58 and other services 60.

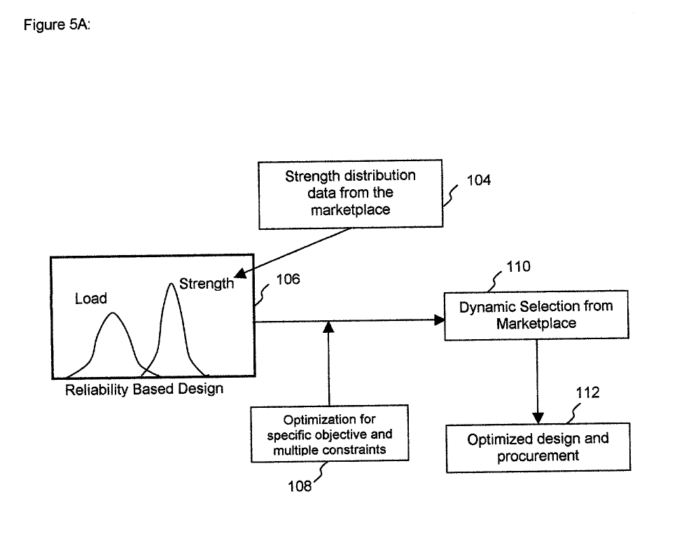

FIG. 4A is an example of integrated design & procurement of pipelines using systems methods and processes depicted in FIGS. 1, 2 & 3. In this system user(s) is continually and dynamically involved in a definition 72, a hydraulics design 74, a pipe design 76, a procurement 78, a logistics 80, and a fulfillment 82 phases of a pipeline design and procurement project. A user can interact with any one of the modules at any time. Market data is continually available for multiple iterations and optimization.

FIG. 4B provides a flow chart of the gas pipeline design and procurement process depicted in FIG. 4A. A user as a first step sets up a project and enters all the relevant project and case parameters 84. This enables identification, storage and retrieval of all data for future use. Next, in step 86 a user enters gas phase data. In step 88 hydraulics design parameters are supplied. Followed by fluid phase parameters in 90 and materials parameters in 92. In step 94 the design calculations module is invoked, which uses technical and financial data from the marketplace 96 to perform design calculations and determine the pipe specifications. These specifications are then used to search 98 the market database to match available pipe that meet the specifications. The selected pipe meeting the criteria are listed 100. A decision layer 102 helps a user to decide if the optimal solution is obtained. User has the option to return to any one of the points 86-94 to evaluate alternate scenarios, and further optimize and refine search. Once the solution is found the process leads to internal approval processes 103, and then to marketplace for procurement.

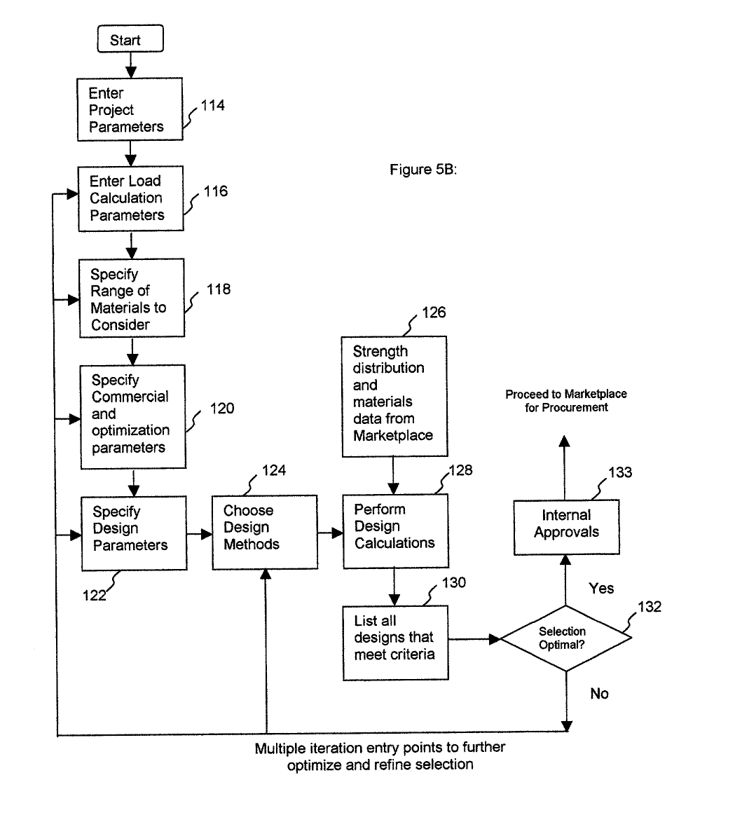

FIG. 5A is one embodiment of the present invention showing an example of Optimized Reliability Based Design (ORBD™) of subsurface equipment closely integrated with Marketplace for dynamic optimized design and procurement. The first concept of this embodiment is reliability based design 106 method where the load on the equipment and the strength of the equipment to be used are both treated as probability distribution functions. The design criterion then is reliability of the design for various failure modes. The methods and the associated algorithms will be discussed in a related patent. A second concept of this invention is that the strength distribution data 104 comes from the marketplace. This data is dynamic with periodic updates from the manufactures. A third concept of this invention is the integration of engineering design calculations with overall optimization for a specific objective and for multiple constraints 108. Each enterprise or a user may have a different objective to optimize, and may have different set of constraints. A design that is optimized to a specific reliability and objective function through dynamic interaction with the marketplace 110 allows for selection of the equipment. Thus an optimized design and procurement is obtained 112.

FIG. 5B is a flow chart of the systems and methods described in Figure SA. A project management module 114 allows a user to enter project and case parameters. Module 114 enables identification, storage and retrieval of project and user data. In step 116, a user enters load calculation parameters that are relevant to that particular equipment that is considered for design. Subsequently, a user specifies the range of material to consider, in interface 118. This sets up some of the material constraints. In the next step 120, commercial and optimization parameters are specified, which will set up the objective function for over all optimization. A user would then specify design parameters 122 and choose the design methods 124. For example, the type of limit state functions to be used in the design analysis. A module 128 which performs the design and optimization calculations encompasses the second and third concepts introduced in FIG. 5A. Module 128 connects to a database interface 126, which brings in strength distribution and materials data from database 64. After the calculations are performed, the results are matched with the market data, a list of all equipment which meet the design and optimization criteria are displayed 130. A decision layer 132 enables a user to perform multiple iterations with an option to enter any of the modules 116-124. If the solution is optimal, user chooses to enter the internal approval processes 133, and then to marketplace for procurement.

The above-described arrangement is largely illustrative of the principles of the current invention. These computer-based methods, systems, processes and principles apply to a broad range of industries such as downstream petroleum, chemicals, financial, and telecom/internet networking. In the downstream petroleum or the chemical industry for example, one can easily envision the application of these systems to the design, engineering and procurement of a distillation column, a tower or a heat exchanger. In the financial arena, we can see the system considering various capital investment opportunities tied together with financing options associated with risk factors, and all of these linked to the financial marketplace. In the telecom/Internet networking world one can envisage the design of a complex network of computers, routers, switches, storage devices with an objective of optimizing managing data traffic, data storage and retrieval, resource sharing, etc., considering the associated risk factors, and the financial objectives and constraints. The overall optimization would involve the selection and procurement of multitude of equipment that are available on the marketplace at any given time frame.

### CONCLUSIONS, RAMIFICATIONS AND SCOPE

Accordingly, the reader will see that the system and method of the integrated technology/marketplace hub combines and streamlines the engineering-to-procurement business processes and supply chain. The Web based architecture of the hub enables easy access over the Internet or a local intranet, for a broader class of users at lower costs. A direct benefit of this system is through reduction in cycle-time and increase in productivity. The hub provides connectivity to back office systems to perform all internal processes, and connects to external catalogs, marketplaces and services for broader reach. It is a full function hub. The design methodology provided combines real-time market data to obtain better design and match with available equipment. In addition, the optimization methods provided combine technical and financial parameters to determine the optimal solution for any given objective. Further, a probabilistic method that uses probabilistic material data from the marketplace provides a reliability-based design. This when combined with optimization including economic parameters provides a risk weighted optimal design.

Although the description above contains many specifications, and that they are illustrated using the Upstream Petroleum Industry examples, these should not be construed as limiting the scope of the invention but as merely providing illustrations of the presently preferred embodiments of this invention. The system and methods can be applied to a broad range of industries such as downstream petroleum, chemicals, financial, and telecom/internet networking. In addition, while the system as described above integrates the design, engineering and optimization technology module with the online marketplace and procurement module(s) in order to deliver the best value for customers, relative to the prior art the design, engineering and optimization technology module is sufficiently unique and novel that even by itself it is an improvement over the prior art and will create value even if integrated with existing systems and marketplaces.

Thus the scope of the invention should be determined by the appended claims and their legal equivalents, rather by the examples given.

What is claimed is:

1. A computer-based method and a system for integrating the Design/engineering-to-procurement business process supply chain comprising:
a system of web-centric technology hub with seamless connectivity to buyers/users, sellers, marketplaces, content providers and other services.

2. Computer-based design methodology that integrates market technical/financial data for optimal design comprising:
first, an integrated pipe design, selection and full function procurement system comprising:
a project definition module with a project, case tree structure and data storage capabilities for logical storage, retrieval, and use enabling the user to easily keep track of various projects and alternative cases, use existing data of other projects to create a new project eliminating entry of standard data again and again, and easily store and retrieve data to perform additional calculations;
a hydraulics design module, which performs the hydraulics calculations necessary for the mechanical design;
a pipe mechanical design module;
an interface for dynamic connectivity between market (technical and financial) data;
a search and selection module considering optimization objective functions and constraints;
a results display layer; and
a decision layer that enables iterations at multiple levels for refining search and optimizing results;
and second, an integrated probabilistic optimized reliability/risk based design (ORBD™) methods which uses dynamic market technical and financial data coupled with constrained based optimization techniques for optimal risk weighted design and procurement comprising:
a project definition module with a project, case tree structure and data storage capabilities for logical storage, retrieval, and use enabling the user to easily keep track of various projects and alternative cases, use existing data of other projects to create a new project eliminating entry of standard data again and again, and easily store and retrieve data to perform additional calculations;
a load calculation module, which considers different limit states and various physical parameters and their variability to determine the probability distribution function of load;
a module that considers the range of materials to consider for application;
an input module for commercial and optimization parameters;
a module for specifying design parameter and design methods;
an interface for dynamic connection to probabilistic technical data from the marketplace;
a design calculation module, which uses the said data to perform design and engineering and optimization calculations;
a search selection module using optimization results;
a results display layer;
a decision layer that enables multiple iteration entry points to further optimize and refine selection; and
a marketplace and back office connectivity layer that enables back office processes and full function procurement.

3. A computer-based method and a system of mathematical techniques that simultaneously combine engineering and commercial variables for optimal risk weighted economic decisions comprising:
a method for constructing engineering equations and optimization objective functions and constraints;
a set of methods and algorithms to solve different classes of equations; and
a probabilistic method of design combined with above said methods for risk/reliability-weighted optimization.

4. A computer-based system for dynamic integrated collaborative engineering and procurement for improved cycle time and productivity comprising:
a software platform that integrates engineering technologies and commercial back office and procurement systems;
a system with real-time links to external marketplaces;
a link system that seamlessly connects buyers and sellers for transactions and fulfillment;
a design and engineering method, which accesses and uses real-time market data to obtain optimal results;
a system to analyze results, evaluate alternative scenarios and search for better results;
a direct and seamless link to back office system and marketplace for procurement; and
a dynamic link to marketplace to execute all marketplace functions including transactions, financial services, fulfillment, logistics and other services.

5. A software system of the above which is web-centric and is deployed as a hosted environment comprising:
a hub on the Internet, which hosts all the technologies, specific content/data, marketplace functionalities, links to other marketplaces and other services;
a local format for the database, which is specific to the technologies and their operations;
a security system that will enable users store and access their project specific data on a continual basis; and
a secure system that will mark and store supplier data that is unique to the user.

6. An extension to the system in claim 5, which will enable the deployment of the hub on a client infrastructure for access on local area networks.

7. A computer-based method for design and engineering technologies, integration methods and optimization of engineering-to-procurement business process supply chain, comprising:
storing all the necessary information related to such design, engineering and procurement technologies and processes in a computer, random access memory, magnetic storage device, or an optical storage device;
linking said computer to at least one user terminal through a data communication link; and displaying, at said user terminal, information concerning design, engineering and procurement technologies and processes.

8. A computer-based method, as defined above, wherein storing includes storing information regarding all parameters and probability distribution functions required in design, engineering and optimization calculations, and risk factors and historical values of various categories of risk used to evaluate risk weighted decisions; and all data related to procurement, financial, and fulfillment functions; and equipment and material data comprising material specification, codes, reference numbers, etc.; and market data comprising availability, quantity, inventory, shipping methods and duration, rates, user specific rates, etc.
